(19) United States
(12) Patent Application Publication
(10) Pub. No.: US 2006/0280188 A1
(43) Pub. Date: Dec. 14, 2006

(54) Method and system for processing frames in a switching system

(75) Inventors: Jack C. Wybenga, Plano, TX (US); Patricia K. Sturm, Marion, IA (US); Yingwei Wang, Dallas, TX (US); Pradeep Samudra, Plano, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/150,814

(22) Filed: Jun. 10, 2005

(51) Int. Cl. H04L 12/28

(52) U.S. Cl. 370/395.53

(57) ABSTRACT

A method for processing frames in a switching system is provided. The method includes performing a data striping technique on an incoming high data rate (HDR) data stream having a high data rate to generate a plurality of lower data rate (LDR) stripes having a lower data rate than the high data rate. The plurality of LDR stripes is processed using processing techniques associated with the lower data rate. The processed LDR stripes are multiplexed into a single, outgoing HDR data stream.

### CROSS-REFERENCE TO RELATED APPLICATION

The present invention is related to that disclosed in U.S. patent application Ser. No. [Atty. Docket No. 2004.02.002.BN0], filed concurrently herewith, entitled “Method and System for Switching Frames in a Switching System.” U.S. patent application Ser. No. [Atty. Docket No. 2004.02.002.BN0] is assigned to the assignee of the present application. The subject matter disclosed in U.S. patent application Ser. No. [Atty. Docket No. 2004.02.002.BN0] is hereby incorporated by reference into the present disclosure as if fully set forth herein.

### TECHNICAL FIELD OF THE INVENTION

The present invention relates generally to wireless networks and, more specifically, to a method and system for processing frames in a switching system.

### BACKGROUND OF THE INVENTION

Ethernet can operate in two basic modes: 1) Carrier Sense Multiple Access with Collision Detection (CSMA/CD), known as Half Duplex or Shared Ethernet, and 2) Point-to-Point, known as Full Duplex or Switched Ethernet. As the data rates increase, either the network diameter decreases or the slot time must increase because of the round-trip delay constraint imposed by CSMA/CD. The round-trip delay constraint for collision detection provides that the time to transmit a packet must be greater than the round trip time for a signal to travel between the two farthest stations; i.e., it must send at least twice the total cable length in bits for any transmission.

For currently implemented 1-Gigabit Ethernet (GbE), the slot time had to be increased to 512 bit times to give a reasonable network diameter of 300 meters. This large slot time leads to high overhead for small packets, so the throughput decreased. Packet bursting was used to improve this throughput.

For 10 GbE and higher these trade-offs between slot time and network diameter become more unpalatable, so shared (half duplex) Ethernet is not an extremely attractive option. Full duplex Ethernet does not suffer from this restriction in round-trip delay time. Current networks have been converting to switched (full duplex) Ethernet as switching technologies have become more cost effective to provide higher performance. Thus, the need for half duplex operation is becoming a smaller factor. For the higher speed Ethernets, such as 10 GbE and beyond, half duplex operation is non-existent.

There is a desire to use Ethernet technology to displace ATM, Frame Relay, and SONET in the core network, providing end-to-end Ethernet connectivity. The advantages of end-to-end Ethernet connectivity include (i) fewer technologies to support; (ii) simpler, cheaper technology due to eliminating the complex, expensive SONET connections; (iii) elimination of expensive protocol conversions that get more difficult as the data rates increase; (iv) improved support for Quality of Service (QoS) because protocol conversions can lead to a loss of the priority fields; and (v) improved security because security features may not be retained through the protocol conversions.

Newer applications are driving the data rates of the core network, as well as the local networks, continually higher. Currently, 1 GbE is readily available and 10 GbE is becoming more common. The Galaxy-V6 system provides 1 GbE network interfaces and uses 10 GbE HiGig inter-connections between the routing nodes and the switch modules. Still, the demand for even higher data rates has continued. Applications driving these increased data rates include (i) grid computing; (ii) large server systems; (iii) high performance building backbones; and (iv) high capacity, long lines. However, current switching systems have been unable to provide processing of frames at data rates much higher than 10 Gigabits/second.

Therefore, there is a need in the art for an improved switching system that is capable of processing frames at data rates higher than 10 Gigabits/second. In particular, there is a need for a switching system that is able to process Ethernet frames at data rates of up to 100 Gigabits/second and higher.

### SUMMARY OF THE INVENTION

In accordance with the present invention, a method and system for processing frames in a switching system are provided that substantially eliminate or reduce disadvantages and problems associated with conventional methods and systems.

To address the above-discussed deficiencies of the prior art, it is a primary object of the present invention to provide a method for processing frames in a switching system. According to an advantageous embodiment of the present invention, the method comprises performing a data striping technique on an incoming high data rate (HDR) data stream having a high data rate in order to generate a plurality of lower data rate (LDR) stripes having a lower data rate than the high data rate. The plurality of LDR stripes is processed using processing techniques associated with the lower data rate. The processed LDR stripes are multiplexed into a single, outgoing HDR data stream.

According to one embodiment of the present invention, the incoming HDR data stream is received at an incoming port and the outgoing HDR data stream is transmitted from an outgoing port. The outgoing HDR data stream is essentially the same data stream as the incoming HDR data stream.

According to another embodiment of the present invention, multiplexing the processed LDR stripes comprises multiplexing the processed LDR stripes using optical time division multiplexing.

According to still another embodiment of the present invention, the LDR stripes comprise parallelized channels of the incoming HDR data stream and the processed LDR stripes comprise parallelized channels of the outgoing HDR data stream.

According to yet another embodiment of the present invention, a channel is provided for each LDR stripe and each channel is synchronized before the switching system enters a traffic mode.

According to a further embodiment of the present invention, synchronizing each channel comprises (i) sending an idle cycle and a first clock signal to a receiver, (ii) receiving the idle cycle and the first clock signal at the receiver, (iii) based on receiving the idle cycle, comparing the first clock signal and a second clock signal at the receiver, where the second clock signal is local to the receiver, and (iv) if the first and second clock signals are unsynchronized, adjusting a timing skew for the second clock signal to synchronize the second clock signal with the first clock signal.

According to a still further embodiment of the present invention, processing the plurality of LDR stripes comprises making a forwarding decision for the plurality of LDR stripes and switching the plurality of LDR stripes based on the forwarding decision.

According to yet a further embodiment of the present invention, the high data rate comprises 120 Gbps, the lower data rate comprises 10 Gbps, and the plurality of LDR stripes comprises twelve LDR stripes.

According to still another embodiment of the present invention, the data striping technique is operable to create a processing window during which the plurality of LDR stripes may be processed.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary switching system that is capable of processing 100-Gigabit Ethernet frames according to the principles of the present invention;

FIG. 2 illustrates a frame format for a 100-Gigabit Ethernet frame that may be processed by the switching system of FIG. 1 according to the principles of the present invention;

FIG. 3 illustrates a data striping technique for processing frames in the switching system of FIG. 1 according to the principles of the present invention;

FIG. 4 illustrates the operation of the optical time division multiplexer of FIG. 1 according to the principles of the present invention;

FIG. 5 illustrates a timing diagram for synchronizing the channels of FIG. 1 according to the principles of the present invention; and

FIG. 6 is a flow diagram illustrating a method for processing frames using the switching system of FIG. 1 according to the principles of the present invention.

### DETAILED DESCRIPTION OF THE INVENTION

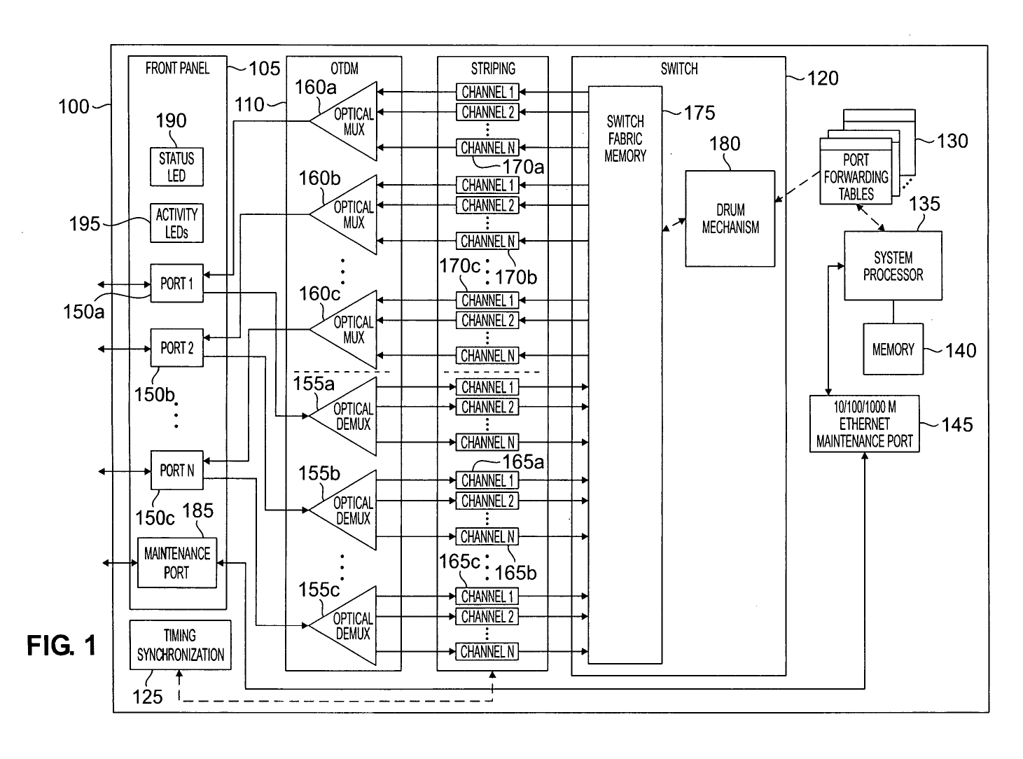

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged switching system.

FIG. 1 illustrates an exemplary switching system 100 that is capable of processing 100-Gigabit Ethernet frames, in addition to other high data rate frames, according to the principles of the present invention. Switching system 100 comprises a full duplex, point-to-point 100 Gbps Ethernet system that is operable to process a 120 Gbps serial data stream placed onto a fiber using a single wavelength. In order to create a processing window and to allow the use of lower speed, such as 10 Gbps, modulation techniques, the optical signal is separated into a plurality of electrical channels through a striping technique.

Switching system 100 comprises a front panel 105, an optical time division multiplexing (OTDM) module 110, a striping module 115, and a switch 120. Switching system 100 also comprises a timing synchronization module 125, port forwarding tables 130, a system processor 135, a memory 140, and a maintenance port application 145.

According to one embodiment, switching system 100 is implemented using a star concept with between 4 and 8 point-to-point, high data rate Ethernet ports 150 in the front panel 105. An incoming, high data rate, serial data stream is separated into a specified number of lower data rate channels using a striping process to create a processing window that allows electronic processing, forwarding decisions, and switching at the lower data rate.

For a particular embodiment, the high data rate comprises approximately 100 Gbps, the lower data rate comprises approximately 10 Gbps, and the specified number of channels comprises twelve. However, it will be understood that other suitable values may be used for the high data rate, the lower data rate, and the specified number of channels without departing from the scope of the present invention. In addition, switching system 100 may be implemented for a system other than an Ethernet system without departing from the scope of the present invention.

Using twelve channels with 10 Gbps for each channel results in a total of 120 Gbps of throughput, with the extra 20 Gbps available to support the overhead used by the striping process. Thus, switching system 100 provides for a data rate of 120 Gbps in order to provide switching for incoming data streams comprising 100 Gbps of data.

OTDM module 110 comprises an optical demultiplexer 155 for each port 150 and an optical multiplexer 160 for each port 150. Striping module 115 comprises a set of channelized port receivers 165 for each optical demultiplexer 155 and a set of channelized port transmitters 170 for each optical multiplexer 160. The number of sets of channelized port receivers 165 and transmitters 170 corresponds to the number of stripes for switching system 100.

In operation, according to a particular embodiment, an incoming data stream received at an incoming port 150 is sent to an optical demultiplexer 155 in OTDM module 110, where the stream is separated into twelve stripes, or channels, and provided to the set of channelized port receivers 165 in striping module 115 that corresponds to the optical demultiplexer 155. The stripes are sent from the set of channelized port receivers 165 to a switch fabric memory 175 in switch 120, where a drum mechanism 180 switches the stripes to the appropriate output port 150.

Thus, switch 120 is memory-based using drum mechanism 180 with one position for each port 150 to provide switching. Each port 150 has its own forwarding table 130, which helps to keep the forwarding tables small and keeps access times predictable by avoiding memory contention among the port processes. Frames are demultiplexed, striped, and placed into switch fabric memory 175 by the channelized port receivers 165.

After switching provided by drum mechanism 180, the stripes are then sent from switch fabric memory 175 to the set of channelized port transmitters 170 associated with the output port 150 identified by the drum mechanism 180, where the stripes are provided to the optical multiplexer 160 corresponding to the output port 150. The optical multiplexer 160 multiplexes the twelve stripes into a single, 120 Gbps serial output data stream as an optical signal on a single fiber. OTDM module 110 then provides this optical signal to the output port 150, which sends the optical signal out.

In this way, striping opens up a window for processing, during which switch 120 is able to determine the output port 150 for the frame using lower data rate processing techniques. OTDM module 110 is operable to multiplex the striped data into a single serial data stream on a single wavelength at the output. To support the multiplexing/demultiplexing processes, timing of each channel is synchronized with the incoming data stream. Timing synchronization module 125 is operable to ensure accurate timing of each channel in order to support this multiplexing process.

System processor 135 and memory 140 are operable to provide management functions for switching system 100. Maintenance port application 145 is operable to provide maintenance functions through the use of a maintenance port 185 in front panel 105. In addition, front panel 105 may comprise a status LED 190 and activity LEDs 195, and/or other similar indicators, to provide information concerning the operation of switching system 100.

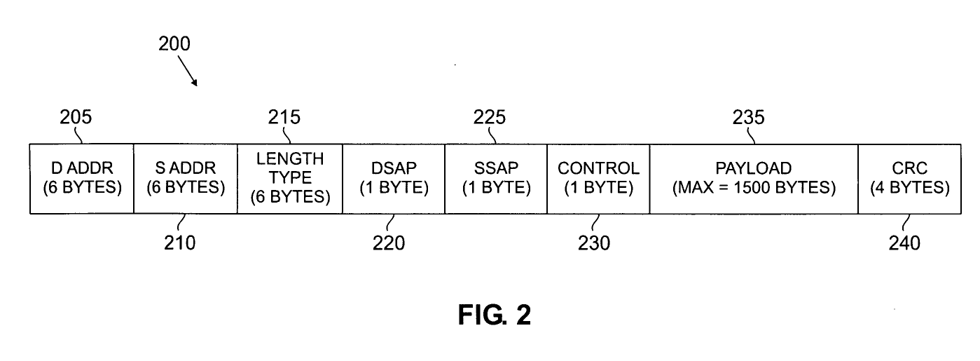

FIG. 2 illustrates a frame format 200 for a 100-Gigabit Ethernet frame that may be processed by switching system 100 according to the principles of the present invention. Frame format 200 comprises eight fields. Destination address (D Addr) field 205 comprises six bytes and provides a physical destination address that specifies to which adapter the data frame is being sent. Source address (S Addr) field 210 comprises six bytes and provides a physical source address that specifies from which adapter the message originated.

Length/Type field 215 comprises two bytes which generally specifies the length of the data in the frame. Destination service access point (DSAP) 220 comprises one byte and provides a logical destination address that acts as a pointer to a memory buffer in the receiving station. Source service access point (SSAP) 225 comprises one byte and provides a logical source address that acts as a pointer to a memory buffer in the originating station. Control field 230 comprises one byte and indicates the type of frame.

Payload field 235 comprises a maximum of 1500 bytes and provides the actual payload data for the frame. Payload field 235 may be padded to ensure that the entire frame format 200 comprises a multiple of 192 bytes. Thus, if data needs to be added to reach a multiple of 192 bytes, “don't care” data may be appended to the payload data in payload field 235 to reach the correct number of bytes. Cyclical redundancy check (CRC) field 240 comprises four bytes and provides error checking data for the frame.

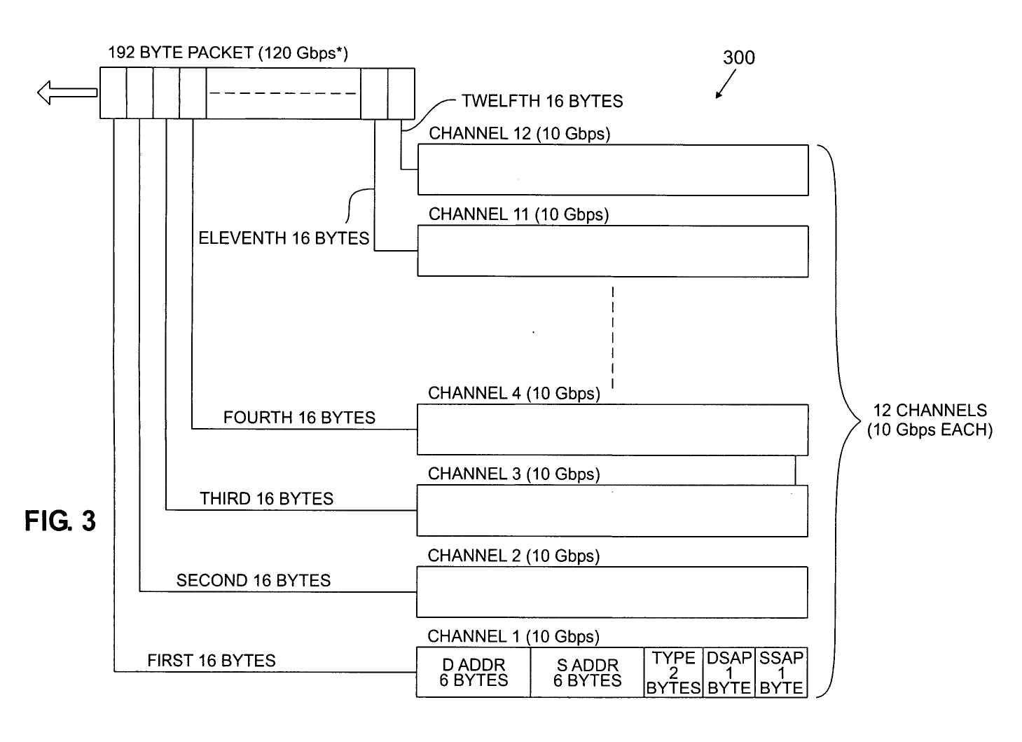

FIG. 3 illustrates a data striping technique 300 for processing frames in switching system 100 according to the principles of the present invention. The data striping technique 300 illustrated in FIG. 3 involves a 100 GbE system that provides twelve channels, each of which are processed using 10 Gbps processing techniques. However, it will be understood that the data striping technique 300 may be configured to process any suitable high data rate system by striping the high data rate data stream into any suitable number of lower data rate data streams without departing from the scope of the present invention.

For the illustrated embodiment, blocks of 192 bytes each are striped into twelve channels of 16-byte stripes. Frames are filled to be a multiple of 192 bytes. Thus, as described in more detail above in connection with FIG. 2, “don't care” data may be added to each frame to reach a multiple of 192 bytes.

The data striping technique 300 provides for separating the 120 Gbps channel into twelve stripes of 10 Gbps each. Performing this striping creates a timing umbrella, or processing window, during which the packets may be processed and also allows 10 Gbps modulation techniques to be used.

For the illustrated embodiment, the first 16 bytes of each packet are sent to the first channel, the second 16 bytes are sent to the second channel, and so on. If there are more than 192 bytes of data for a particular frame, then additional sets of twelve channels are used. The length field 215 in the packet header may be used to determine how many sets of stripes are included in a frame.

Twelve, instead of ten, channels of 10 Gbps are used to absorb the overhead, such as padding, introduced by the stripe processing. In addition, parallel optics typically support twelve channels. If a typical traffic mix of 50% minimum 64 byte packets, 25% of midsize 500 byte packets, and 25% of large 1500 byte packets is assumed, this gives an average packet size of:
0.5(64 bytes)+0.25(500 bytes)+0.25(1500 bytes)=532 bytes
and a bandwidth distribution of:

64 bytes packets: 0.5 * (64/532)≅6%

500 byte packets: 0.25 * (500/532)≅23.5%

1500 byte packets: 0.25 * (1500/532)≅70.5%
The padding overhead for this traffic mix is:

$$\begin{matrix}Overhead = 0.06 * Ceiling ( 64 / 192 ) * 192 / 64 + 0.235 * \\ Ceiling ( 500 / 192 ) * 192 / 500 + 0.705 * \\ Ceiling ( 1500 / 192 ) * 192 / 1500 \\ = 0.06 * 3 + 0.235 * 1.152 + 0.705 * 1.024 \\ = 1.17 .\end{matrix}$$

Therefore, the channelized bandwidth that would be needed for this particular traffic mix would be 100 Gbps * 1.17=117 Gbps. Thus, 120 Gbps of channelized bandwidth is sufficient to handle the padding overhead for typical traffic mixes.

If a packet had to be processed and switched between the last bit of the destination address 205 and the next bit of the packet, then there would be only 10 ps (a single bit time) in which to process and switch the packet. Data striping technique 300 creates a processing window for processing and switching because the processing and switching do not need to be completed until the last bit of the set of stripes is handled. Since there are a minimum of 192 bytes in the set of stripes and since the destination address 205 is provided in the first six bytes of the first stripe, as described above in connection with FIG. 2, there is a processing window of (192 bytes−6 bytes) * 8 bits/(120 * 10⁹ bits/s)≅12.4 ns to process the packet after the destination address 205 is received. Thus, pipelining is built into the stripe structure.

As previously mentioned, another reason for using data striping technique 300 is to be able to use 10 Gbps direct modulation to process 100 Gbps data streams. Twelve parallel sets of 10 Gbps modulators are used for the illustrated embodiment.

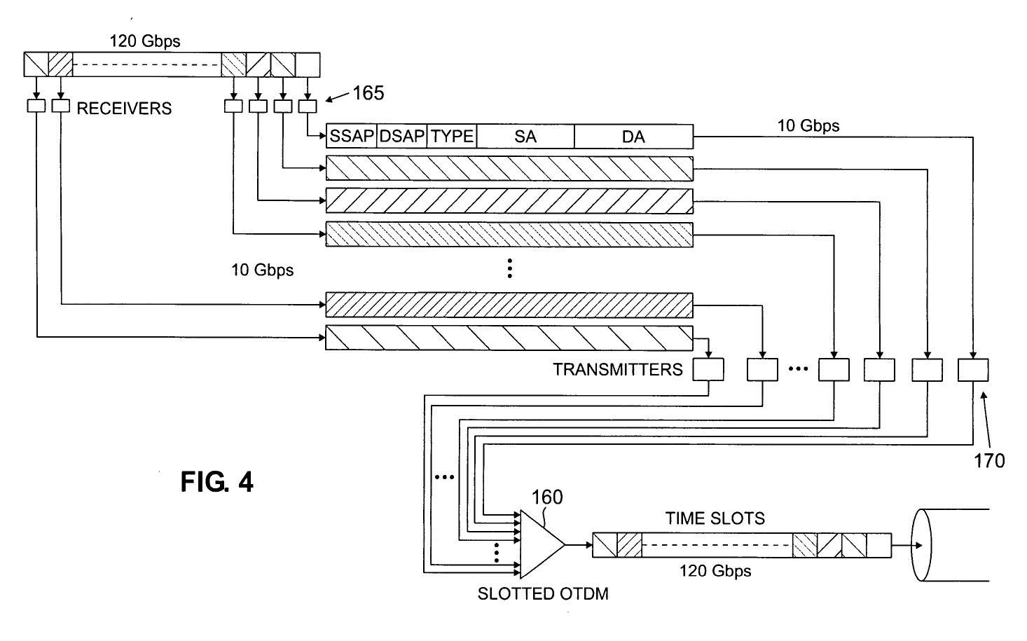

FIG. 4 illustrates the operation of the optical time division multiplexing (OTDM) module 110 according to the principles of the present invention. For one embodiment, optical multiplexer 160 comprises a slotted optical time division multiplexer. Slotted optical time division multiplexing uses slots, with a stripe from each channel occupying a slot such that one slot comprises twelve stripes. Optical multiplexer 160 multiplexes a number of low-bit rate optical channels in the time domain. Using striping and optical time division multiplexing, signal processing, switching and routing may take place at the slot rate of 10 Gbps instead of 100 Gbps. Thus, optical time division multiplexing in OTDM module 110 overcomes electronic speed limitations of currently available electronic components, which are generally limited to about a 10 Gbps data rate.

Channel allocation in optical time division multiplexing depends on the electrical data rate (e.g., 10 Gbps) and on the optical pulse width. The optical pulse width is shortened so that more channels can be multiplexed into an electrical clock period. Thus, for the illustrated embodiment, the pulse width is shortened to accommodate twelve stripes or channels.

The shortened pulses reduce cross-talk between the channels, but the short optical pulses experience heavy dispersion when traveling long distances. The chromatic dispersion at 1550 nm is high, limiting the link span to 50 km at 300 Gbps. However, 100 Gbps with a maximum run length of 300 meters is supported.

A 100 Gbps serial data stream that has been demultiplexed into twelve stripes by an optical demultiplexer 155 is provided to a set of channelized port receivers 165 in striping module 115. After switching, each stripe is eventually provided to a channelized port transmitter 170. The set of channelized port transmitters 170 then provide the stripes to an optical multiplexer 160, which recombines the twelve stripes of 10 Gbps data into a single 120 Gbps serial data stream. The twelve multiple data streams of the twelve channels are superimposed using optical time division multiplexing to create the 120 Gbps serial data stream. The timing of each channel is synchronized using a training/learning process, thus allowing the transmitters 170 of each channel to put their data into the defined time slots.

Although optical demultiplexer 160 may demultiplex the data stream using electro-optical switching or using all optical switching, electro-optical switching may perform better for speeds below 40 Gbps, while all optical switching may perform better for higher data rates because it is based on third order non-linear optical effects whose response is in the femto second range.

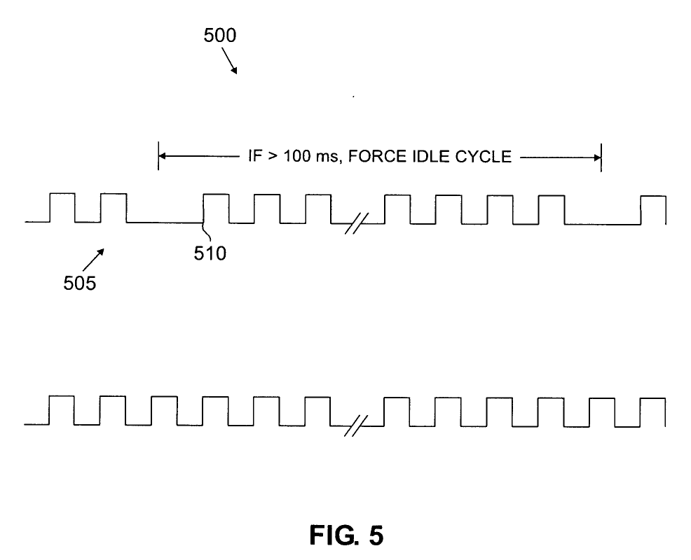

FIG. 5 illustrates a timing diagram 500 for synchronizing channels according to the principles of the present invention. The approach to timing synchronization is to train each link segment separately before starting to pass traffic. Thus, timing is synchronized when the packets arrive and the timing of the 100 GbE interface is plesiochronous, rather than asynchronous.

As described above in connection with FIG. 2, the frame format 200 for the 100 GbE frame comprises neither a preamble field nor a Start Frame Delimiter (SFD) field. Lower speed Ethernet links use these fields to allow asynchronous operations. The preamble field is an alternating series of 1s and 0s that ends with a zero and is used to allow the physical signaling layer to stabilize. The SFD field is a special code (e.g., 10101011) used to denote the start of the frame.

Instead of using the preamble and SFD fields, timing in switching system 100 is synchronized through a training/learning process. Each end trains the other end by sending an idle cycle 505. This idle cycle 505 is missing a low-to-high transition. The next low-to-high transition 510 following the idle cycle 505 is used to synchronize timing. The receiver learns by comparing the rising edge of its clock to the received low-to-high transition 510 following the idle cycle 505 and adjusting its timing accordingly.

Current electronics are limited to handling data rates of about 10 Gbps. To achieve the 120 Gbps throughput used for 100 GbE in switching system 100, a data striping technique 200 together with optical time division multiplexing is used. The data stream is broken down into twelve stripes (or channels), each running at 10 Gbps. These channels are optically multiplexed together to form the 120 Gbps serial data stream. Each channel is separately synchronized using this synchronization approach.

According to one embodiment, timing synchronization module 125 forces synchronization on each channel every 100 ms by ensuring that an idle cycle 505 is generated at least once every 100 ms. Because it is not practical to fully fill the channel capacity at all times, however, timing synchronization module 125 may not have to force idle cycles 505. Following each received idle cycle 505, channel timing is resynchronized as described above. In addition, for one embodiment, switching system 100 supports 10 bits of timing skew, which provides about 100 ps, or approximately 1 inch, of path differential. In this way, timing is synchronized on each channel prior to switching system 100 entering a traffic mode in which data may be sent on that channel.

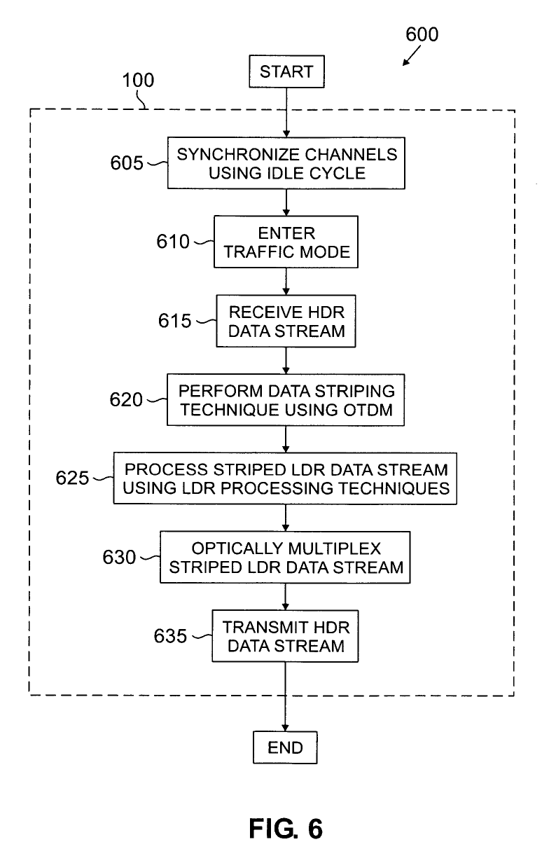

FIG. 6 is a flow diagram illustrating a method 600 for processing frames using switching system 100 according to the principles of the present invention. Initially, channels are synchronized using an idle cycle 505 (process step 605). For example, an idle cycle 505 and a first clock signal may be sent to a receiver, which enters a learning mode based on receiving the idle cycle 505. The receiver then compares the first clock signal to a second, local clock signal. If the first and second clock signals are unsynchronized, the receiver adjusts a timing skew for the second clock signal to synchronize the second clock signal with the first clock signal. Switching system 100 enters a traffic mode after synchronization (process step 610).

A high data rate (HDR) data stream is received at an input port 150 (process step 615). For example, a 120 GbE data stream may be received at the input port 150. A data striping technique 300 is performed on the HDR data stream using optical time division multiplexing (process step 620). This results in the creation of a specified number of stripes, or channels, of lower data rate (LDR) data streams. For example, twelve channels of 10 Gbps data streams may be generated by the data striping technique 300.

The striped LDR data stream, or the specified number of channels of LDR data streams, is processed during the processing window created by the striping technique 300 using processing techniques associated with the lower data rate of the LDR data streams (process step 625). Thus, for example, twelve 10 Gbps data streams may each be processed using 10 Gbps modulation techniques.

After processing, which may include electronic processing, forwarding decisions, and switching at the lower data rate, the specified number of stripes of the striped LDR data stream are optically multiplexed into a single, high data rate, serial output data stream as an optical signal on a single fiber (process step 630). For example, twelve 10 Gbps stripes may be multiplexed into a single 120 Gbps data stream. Finally, switching system 100 transmits the HDR data stream from the output port 150 identified during processing (process step 635).

Although the present invention has been described with an exemplary embodiment, various changes and modifications may be suggested to one skilled in the art. It is intended that the present invention encompass such changes and modifications as fall within the scope of the appended claims.

What is claimed is:

1. A method for processing frames in a switching system, comprising:
performing a data striping technique on an incoming high data rate (HDR) data stream having a high data rate to generate a plurality of lower data rate (LDR) stripes having a lower data rate than the high data rate;
processing the plurality of LDR stripes using processing techniques associated with the lower data rate; and
multiplexing the processed LDR stripes into a single, outgoing HDR data stream.

2. The method as set forth in claim 1, further comprising:
receiving the incoming HDR data stream at an incoming port; and
transmitting the outgoing HDR data stream from an outgoing port, the outgoing HDR data stream comprising essentially the same data stream as the incoming HDR data stream.

3. The method as set forth in claim 1, multiplexing the processed LDR stripes comprising multiplexing the processed LDR stripes using optical time division multiplexing.

4. The method as set forth in claim 1, the LDR stripes comprising parallelized channels of the incoming HDR data stream and the processed LDR stripes comprising parallelized channels of the outgoing HDR data stream.

5. The method as set forth in claim 1, further comprising:
providing a channel for each LDR stripe; and
synchronizing each channel before the switching system enters a traffic mode.

6. The method as set forth in claim 5, synchronizing each channel comprising:
sending an idle cycle and a first clock signal to a receiver;
receiving the idle cycle and the first clock signal at the receiver;
based on receiving the idle cycle, comparing the first clock signal and a second clock signal at the receiver, the second clock signal local to the receiver; and
if the first and second clock signals are unsynchronized, adjusting a timing skew for the second clock signal to synchronize the second clock signal with the first clock signal.

7. The method as set forth in claim 1, processing the plurality of LDR stripes comprising making a forwarding decision for the plurality of LDR stripes and switching the plurality of LDR stripes based on the forwarding decision.

8. The method as set forth in claim 1, the high data rate comprising 120 Gbps, the lower data rate comprising 10 Gbps, and the plurality of LDR stripes comprising twelve LDR stripes.

9. The method as set forth in claim 1, the data striping technique operable to create a processing window during which the plurality of LDR stripes may be processed.

10. A switching system for processing frames in a high data rate data stream, comprising:
an optical time division multiplexing (OTDM) module operable to separate an incoming high data rate (HDR) data stream having a high data rate into a plurality of lower data rate (LDR) stripes having a lower data rate than the high data rate;
a striping module coupled to the OTDM module and comprising a plurality of channelized port receivers, each of a subset of the channelized port receivers operable to receive one of the plurality of LDR stripes from the OTDM module; and
a switch coupled to the striping module, the switch operable to process the plurality of LDR stripes using processing techniques associated with the lower data rate.

11. The switching system as set forth in claim 10,
the striping module further comprising a plurality of channelized port transmitters, each of a subset of the channelized port transmitters operable to receive one of a plurality of the processed LDR stripes from the switch; and
the OTDM module further operable to multiplex the processed LDR stripes into a single, outgoing HDR data stream using optical time division multiplexing.

12. The switching system as set forth in claim 10, further comprising a plurality of ports, the switching system operable to receive the incoming HDR data stream at an incoming port and to transmit the outgoing HDR data stream from an outgoing port, the outgoing HDR data stream comprising essentially the same data stream as the incoming HDR data stream.

13. The switching system as set forth in claim 10, the LDR stripes comprising parallelized channels of the incoming HDR data stream and the processed LDR stripes comprising parallelized channels of the outgoing HDR data stream.

14. The switching system as set forth in claim 10, further comprising a timing synchronization module coupled to the striping module, the timing synchronization module operable to synchronize each channelized port receiver and each channelized port transmitter before the switching system enters a traffic mode.

15. The switching system as set forth in claim 14, the timing synchronization module operable to synchronize each channelized port receiver and each channelized port transmitter by (i) sending an idle cycle and a first clock signal to a receiver, (ii) receiving the idle cycle and the first clock signal at the receiver, (iii) based on receiving the idle cycle, comparing the first clock signal and a second clock signal at the receiver, the second clock signal local to the receiver, and (iv) if the first and second clock signals are unsynchronized, adjusting a timing skew for the second clock signal to synchronize the second clock signal with the first clock signal.

16. The switching system as set forth in claim 10, the switch operable to process the plurality of LDR stripes by making a forwarding decision for the plurality of LDR stripes and switching the plurality of LDR stripes based on the forwarding decision.

17. The switching system as set forth in claim 10, the high data rate comprising 120 Gbps, the lower data rate comprising 10 Gbps, and the plurality of LDR stripes comprising twelve LDR stripes.

18. A method for synchronizing timing for processing frames in a switching system in which each of a plurality of receivers is synchronized before the switching system enters a traffic mode, the method comprising, for each of the receivers:
sending an idle cycle and a first clock signal to the receiver;
receiving the idle cycle and the first clock signal at the receiver;
based on receiving the idle cycle, comparing the first clock signal and a second clock signal at the receiver, the second clock signal local to the receiver; and
if the first and second clock signals are unsynchronized, adjusting a timing skew for the second clock signal to synchronize the second clock signal with the first clock signal.

19. The method as set forth in claim 18, further comprising:
determining whether a specified period of time has elapsed without an idle cycle being sent to the receiver; and
when the specified period of time has elapsed without an idle cycle being sent to the receiver, forcing the sending of an idle cycle to the receiver.

20. The method as set forth in claim 19, the specified period of time comprising 100 milliseconds.
